(19) United States
(12) Patent Application Publication
(10) Pub. No.: US 2022/0166901 A1
(43) Pub. Date: May 26, 2022

(54) COLOR GAMUTS

(71) Applicant: Hewlett-Packard Development Company, L.P., Spring, TX (US)

(72) Inventors: Peter Morovic, Sant Cugat de Valles (ES); Jan Morovic, London (GB); Hector Gomez Minano, Sant Cugat dul Valles (ES)

(73) Assignee: Hewlett-Packard Development Company, L.P., Spring, TX (US)

(21) Appl. No.: 17/418,063

(22) PCT Filed: Aug. 12, 2019
(86) PCT No.: PCT/US2019/046111

§ 371 Date: Jun. 24, 2021

(51) Int. Cl. H04N 1/60

(52) U.S. Cl. CPC H04N 1/6061; H04N 1/603; H04N 1/6022

(57) ABSTRACT

In an example, a method includes obtaining, by a processor, a first set of vertices of a set of simplexes defining a hull of an initial color gamut. A value representing a size of a first simplex of the set of simplexes may be determined and compared to a first threshold. When the determined value is less than the first threshold, at least one vertex of the first simplex may be removed from the first set of vertices to determine a modified color gamut hull.

### BACKGROUND

In order to check and/or calibrate the operation of a printing apparatus, such as an inkjet printer, samples or test patches may be printed and the printed output may be measured, for example to determine if the printed color matches an expected printed color.

### BRIEF DESCRIPTION OF DRAWINGS

Non-limiting examples will now be described with reference to the accompanying drawings, in which:

FIG. 1 is a flowchart of an example method of determining a modified color gamut hull;

FIGS. 2A-E schematically show an example of modifying a color gamut hull in a two dimensional color space;

FIGS. 3A-E schematically show an example of modifying a color gamut hull in a three dimensional color space;

FIG. 4 is a flowchart of another example method of determining a modified color gamut hull;

FIG. 5 is a flowchart of an example method for modifying a color gamut hull;

FIG. 6 is a flowchart of another example method for modifying a color gamut hull;

FIG. 7 is a schematic drawing of an example machine-readable medium associated with a processor; and

FIG. 8 is a simplified schematic drawing of example processing circuitry.

### DETAILED DESCRIPTION

Colors may be described using various color spaces, for example the CIELAB color space describes colors in terms of three variables: L* for the lightness from black to white, a* from green to red, and b* from blue to yellow. Examples of other color spaces are RGB and CMYK. The RGB color space may be used by display devices, such as LCD or LED displays, and describes colors in terms of red (R), green (G) and blue (B). The CMYK color space may be used by printing apparatus, such as inkjet printers, and describes colors in terms of cyan (C), yellow (Y), magenta (M) and black (K). These color spaces are described in terms of three or four variables, however other color spaces may use any number of variables to describe a color. For example printers which use more colors of ink may use a higher dimensional color space to describe the colors to be printed.

Some colors which may be printed by a particular print apparatus may be referred to as, or correspond to, vertices in a color gamut. In some examples, a printing apparatus may print test samples based on such vertices, which may in turn be measured using a colorimeter or the like and thereby used to characterise the accessible color gamut. In some examples, this may be used to determine if the print apparatus is capable of printing colors accurately (i.e. if the printed colors conform to expected colors) and/or to develop mappings between color spaces. For example, an image may be digitally stored with reference to the RGB color space, and may be mapped to a CMYK color space for printing the image. The mapping may be tested and/or calibrated based on measured printed test patches.

While the gamut of a device may include all colors which that device can (or is expected to be able to reproduce), in some examples, the test samples may be samples of colors which lie on the surface, or hull (for example the exterior hull), of the gamut. Even if just vertices on the hull of a gamut are considered, printing each accessible color may result in printing and measuring a high number of color points which may take considerable time and use a large quantity of consumables such as ink and print media.

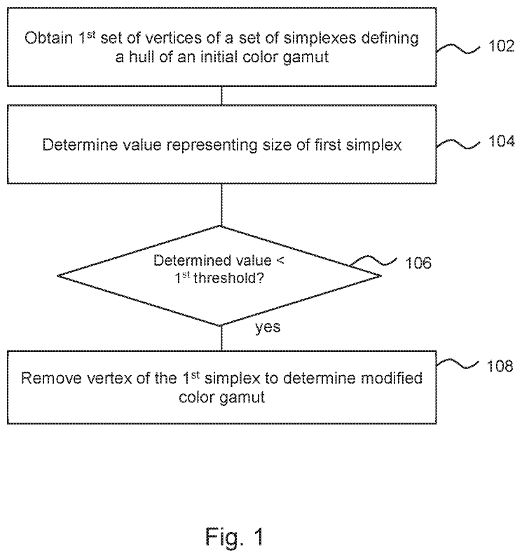

FIG. 1 shows an example of a method, which may be a computer implemented method of determining a modified color gamut hull.

Block 102 comprises obtaining, at a processor, a first set of vertices of a set of simplexes defining a hull of an initial color gamut. The hull may for example be described by a tessellation of the “surface simplexes”. As just the hull, or surface simplexes, are considered, for an N-dimensional color space, the simplexes may be N−1 dimensional simplexes (often referred to simply as “N−1 simplexes”). For example for a three dimensional color space, while the gamut as a whole may be characterised using 3-simplexes (such as tetrahedrons), the surface simplexes, or the simplexes defining the hull, may be 2-simplexes, for example triangles (which may also belong to 3-simplexes characterising the whole gamut).

The vertices of the gamut (or of the simplexes of the hull) may be obtained from a storage medium, for example a storage medium of a printing device or of a computing device associated with a printing device, and/or over a network or the like. The vertices may be stored in the storage medium in a table such as a look up table. In other examples the first set of vertices may be obtained by a computing device or a printing device by performing a computation or conversion from a first color space to a second color space. In other examples vertices defining at least part of the color gamut may be obtained from a measurement. For example, a number of different combinations of print agents such as inks may have been previously printed and measured to determine the accessible gamut. In other examples, a predictive model may be used to generate the gamut associated with a printing apparatus. The initial color gamut may for example be associated with a particular printing apparatus, or a class of printing apparatus. In examples, the color space may be RGB, CMYK, CIELAB or CIEXYZ.

Block 104 comprises determining, by a processor (which may be the same as the processor referred to in relation to block 102) a value representing a size of a first simplex of the set of simplexes. The type of value determined may depend on the dimensions of the color space. For example in a two dimensional color space, a simplex may be a line, and the value representing its size may be its length. In a three dimensional color space, a simplex may comprise a two dimensional shape such as a triangle and the value representing its size may be its area. In higher dimensional color spaces, the value representing the size of the simplex may be the volume of the simplex.

Block 106 comprises comparing, by a processor (which may be the same as the processor referred to in relation to block 102 and/or block 104), the determined value to a first threshold. When it is determined that the determined value is less than the first threshold, the method includes block 108 which comprises removing, by a processor, at least one vertex of the first simplex from the first set of vertices to determine a modified color gamut hull.

The method of blocks 104 to 108 may be repeated for other simplexes of the hull. In this way, simplexes which are smaller than the threshold have at least one vertex removed from them. Simplexes which are smaller will have their vertices spaced closer together and so removing vertices from simplexes with a size below a threshold will result in vertices which are spaced close together being ‘pruned’, or removed, which may in turn providing a relatively uniform distribution of vertices in the modified color gamut hull. In some examples, blocks 104 and 106 may be carried out to identify all simplexes below a threshold size before block 108 is applied (in some examples, conditionally applied as set out in greater detail below) to all identified simplexes.

The method of FIG. 1 therefore provides a method for filtering a number of vertices on hull of a color gamut of a printing apparatus, or sampling the vertices, to determine a subset. Because of the way the vertices are selected for removal, the remaining subset of vertices will provide a relatively well spread and evenly distributed subset, meaning that they may provide an appropriate subset for characterising the color gamut. The remaining subset of vertices could provide the basis for the color(s) (or print instructions) of test sample(s) which may be printed and measured, which may allow characterisation of the gamut without printing and measuring an unduly large number of samples.

In examples, the hull of the initial and/or modified color gamut is an alpha shape or a convex hull. An alpha shape is a bounding surface associated with a set of points in color space (which are also termed vertices herein). A convex hull of a set of points is a specific example of an alpha shape, and is a convex polytope, for example a polygon in two dimensions, with the smallest set of points that encloses all of the set of points. An alpha shape tends to the convex hull when the alpha value of the alpha shape tends to infinity, and therefore the volume of the convex hull provides an upper bound on the volume of an alpha shape. Unlike a convex hull, an alpha shape may be concave.

The set of vertices describing an initial hull (for example, a convex hull or alpha shape) may be relatively large and may be distributed in a non-uniform way such that some portions of the hull comprise a larger number of vertices than other portions of the hull. The method of FIG. 1 may effectively sample the hull of a color gamut to select a set of vertices which may be well suited to characterising the gamut of the printing apparatus.

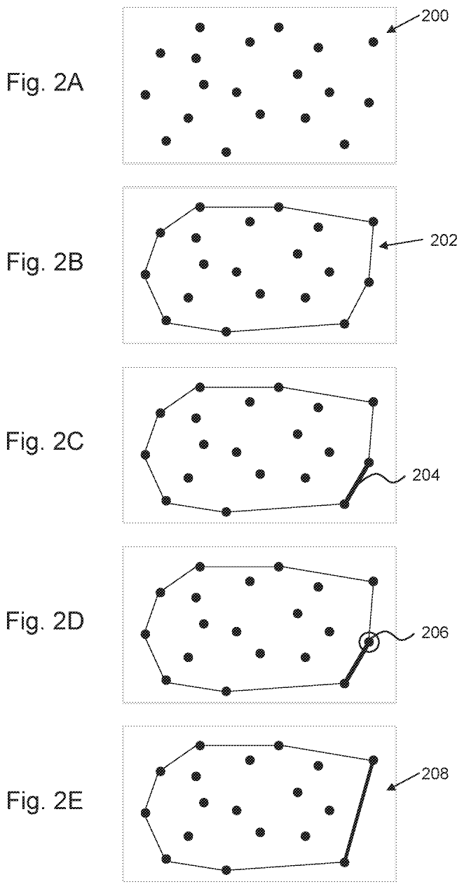

FIGS. 2A-E schematically show the application of the above method to a two dimensional set of vertices 200. FIG. 2A shows the set of vertices 200 in a 2D color space, wherein each vertex represents a color, FIG. 2B also shows the set of simplexes defining a hull 202 of the color gamut. In this example the color space is in two dimensions so the hull, or surface, simplexes are lines (i.e. 1-simplexes). The hull 202 depicted is a convex hull of the color gamut. A value representing a size of a first simplex 204 of the hull 202 is determined, which may be the length of the line representing the first simplex 204 shown in FIG. 20. In this example the determined value is less than the first threshold, so one vertex 206 of the first simplex is selected as shown in FIG. 2D. The selected vertex is then removed, and a modified color gamut hull 208 may be derived as depicted in FIG. 2E.

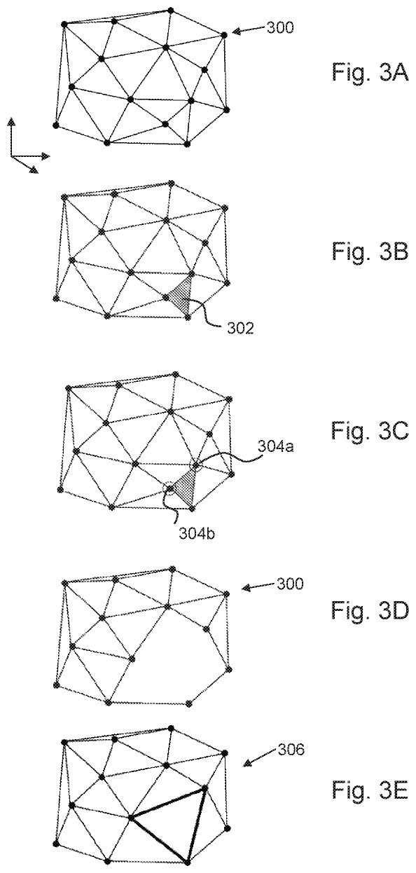

FIGS. 3A-E schematically show a similar method applied to a three dimensional color space. In this example, the initial color gamut is a three dimensional color gamut, the surface simplexes, or hull simplexes, are triangles, and determining the value representing the size comprises determining the area of a triangle (or in some examples, each triangle in turn). In FIG. 3A, a set of vertices 300 represent colors in a three dimensional color space. The vertices 300 are vertices of simplexes defining a hull of an initial color gamut, In FIG. 3B, a value representing the size of a first simplex 302 is determined. In this example the value representing the size is the area of the first simplex 302, and said area is less than the predetermined first threshold, so two vertices 304a, 304b of the first simplex 302 are selected for removal as depicted in FIG. 30. FIG. 3D shows the set of vertices 300 after removal of the two vertices 304a, 304b. FIG. 3E shows the modified color gamut hull 306, in which a new hull tessellation/triangulation of the remaining vertices has been determined, defining the hull 306.

While in these examples, the hull is shown to be re-computed (i.e. re-tessellated) after consideration of a single simplex, in other examples, all simplexes may be considered prior to re-tessellation of the hull.

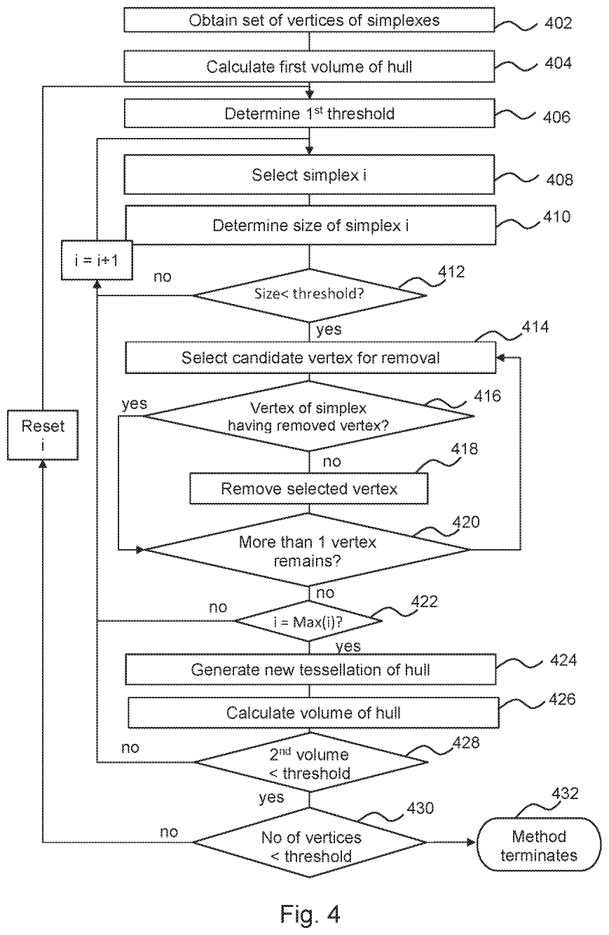

FIG. 4 shows an example of a method, which may be a computer implemented method of sampling an initial color gamut hull to determine a modified color gamut hull. In this example, an operation to remove vertices is carried out iteratively until a condition is met in relation to the volume of the modified hull and the number of remaining vertices.

Block 402 comprises obtaining a first set of vertices of a set of simplexes defining a hull of an initial color gamut, for example as described above in relation to block 102. In block 404, a first volume of the hull of the initial color gamut (i.e. prior to removal of any vertices) is calculated by at least one processor.

In block 406, the first threshold (i.e. the threshold simplex size as referred to in block 106 of FIG. 1) is determined, or calculated. In some examples the first threshold is the median of values representing sizes of the simplexes in the set of simplexes (i.e. the set of surface, or hull, simplexes). In other examples, the threshold may be set in some other way relative to the size of the simplexes, for example being a 60th, 70th or 80th percentile value of sizes (or any other value), or being based on the mean of the sizes, or the like. Selecting a value relative to the sizes of the set of simplexes may be effective if the vertices of the initial gamut are relatively dense and evenly distributed. However, in other examples the first threshold may be based on a percentile of the values representing sizes of the simplexes or may be a predetermined absolute value. In some examples, an absolute or predetermined threshold may provide a more suitable threshold in examples where the vertices of the initial gamut are relatively sparse, and/or unevenly distributed. A suitable predetermined threshold may be determined empirically, for example based on human perceptible color difference. Setting a predetermined threshold provides a threshold to the local error in the gamut volume estimate. For example if a threshold were set to 5 units in the CIE LAB space, then the local error will be at most 5 units.

In block 408, a simplex having index i of the set of simplexes of the hull of the initial gamut hull is selected for consideration. The value i may for example be initially set to 0, wherein each of the simplexes has an integer index from 0 to Max(i) (where the number of simplexes is Max(i) +1). This simplex then serves as the first simplex of FIG. 1. Block 410 comprises determining a value representing a size of the simplex (for example as described in relation to block 104) and block 412 comprises comparing the determined value to a first threshold (for example as described in relation to block 106), which in this example is the threshold calculated in block 406. If it is determined that the size value is not less than the first threshold (i.e. the simplex is larger than the threshold), then no vertices are removed from the selected simplex. Instead, i is incremented and the method returns to block 408 with the selection of a different simplex of the set of simplexes.

If however it is determined in block 412 that the determined size value is less than the first threshold (i.e. the simplex is smaller than the threshold), the method continues to block 414 by selecting a candidate vertex of that simplex for removal.

In some examples the vertex or vertices to be removed from a simplex are selected randomly, In other examples the vertex or vertices are selected by selecting the at least one vertex from the vertices of the first simplex by calculating the sizes of the adjacent simplexes, and selecting at least one vertex which is common to the first simplex and the smallest adjacent simplex. This allows vertices to be selected which are common to two relatively small simplexes. In other examples the vertex/vertices which is/are closest to a mid-point of the gamut may be selected for removal. For example a vertex can be selected which is colorimetrically closest to a mid-point, wherein the mid-vertex is calculated as a colorimetric centre, or a “centre of gravity” of the gamut. Selecting the point closest to the mid-point results in the volume being less affected and protects vertices further from the centre (which are likely to contribute to the gamut volume) from being considered for removal.

In block 416, it is determined if the vertex is part of a second simplex having at least one removed vertex. If so, the vertex is not removed in block 418. In other words, the removal of the vertex of the simplex is conditional on that vertex not being a vertex of a second simplex which has at least one vertex removed therefrom. This condition prevents the removal of too many vertices removed from any local area, which could result in a modified gamut being relatively sparse in that area (and therefore, in turn, that area of the gamut may not be well sampled when it comes to characterising the gamut by printing colors corresponding to the remaining vertices). In another example, a list of selected vertices for removal may be compiled. Each time a candidate vertex is selected for removal, the list is checked to see if this vertex already exists on the list, and if not is added to the list. Othemise, the next vertex/simplex is considered. In FIG. 4, removal of the selected vertex is performed as a separate operation for each selected vertex, however in some examples all the selected vertices may be removed in a single operation based on the generated list.

If it is determined that the vertex is not part of a second simplex having at least one removed vertex in block 416, in this example and in block 420, the selected vertex is removed, and it is determined, in block 422, if there is more than one vertex remaining in that simplex. If so, the method loops back to block 416 and another candidate vertex is selected for removal until all vertices have been assessed and are found to also be vertices of a simplex from which a vertex has been removed, or there is just one remaining vertex of that simplex. Removal of all but one vertex effectively results in the simplex being approximated by the one remaining vertex, representing the contribution of that simplex to the hull.

It is then determined whether the index is set to Max(i) in block 422- i.e. it is determined whether all the simplexes of the hull have been considered. If not, i is incremented, and the method loops back to block 408. If however all the simplexes have been considered, in block 424 a new tessellation of the remaining vertices is determined by at least one processor to provide a modified color gamut hull, and in block 422, the volume of the modified color gamut hull is calculated by at least one processor, this volume being referred to as the second volume herein.

In some examples the difference between the first volume and the second volume is calculated and when the difference is less than a volume loss threshold the process of removing vertices is repeated for the simplexes in the re-tessellated modified color gamut hull. In the example of FIG. 4, however, the second volume is compared to a threshold in block 426. This threshold may for example be based on the first volume (e.g. 99% of the first volume, or 99.5% of the first volume). In some examples the threshold may be in the range of 0.1% to 2%, 0.5% to 2% or 1% to 2% decrease relative to the initial volume. A change in volume in the range 1% to 2% may be within printing and measurement repeatability error, and so does not significantly impact the result, while allowing a significant decrease in the number of hull vertexes (which may form the basis for a set of test samples).

The volume serves as measure of the accuracy of the modified gamut compared with the initial gamut. Therefore by stopping iteration when the volume decreases by a predetermined amount the accuracy can be maintained.

In some examples the values representing the size may be determined for each simplex, and the smallest simplex may be identified. This simplex may have at least one vertex removed, and the remaining vertices may be re-tessellated. The process may be iterated (i.e. the smallest simplex in the new tessellation may be identified), for example until either the number of vertices remaining is below the threshold number of vertices or until the volume loss threshold is exceeded. In other examples, each simplex may be considered in turn, from smallest size to largest size, for example until a volume and/or number of vertexes condition is met.

In this example, if (or once) the second volume is less than the threshold (i.e. the gamut volume is smaller than the threshold volume), the method continues to block 428 as will be described below. When the volume of the modified gamut is greater than the threshold the method returns to block 406, with the index reset. For example i may be reset to 0 and Max(i) may be set to be the number of simplexes in the modified gamut less 1.

A new first threshold may be determined for the modified color gamut hull (for example, being the median of sizes of the simplexes in the modified hull) in block 406. The modified gamut hull is then processed in the same way as the initial color gamut hull, to provide a further modified color gamut hull, the volume of which may again be assessed, and the process of vertex removal being repeated until the gamut volume is less than the threshold. By arriving at the modified gamut volume iteratively, the number of points may be reduced without excessive loss of gamut volume.

Once the volume of the gamut has been reduced to meet the threshold, the method proceeds to block 430, in which the number of remaining vertices is compared to a threshold number of vertices, such that when the number of remaining vertices is greater than a threshold number of vertices, the method loops around to remove further vertices. The threshold number of vertices may for example be predetermined, determined based on an initial number of vertices in the hull, selectable by a user, or determined in some other way. For example a user may select a threshold number of vertices based on a number of color patches they wish to print for calibration. This may allow a user to control the level of sampling, and/or the level of computation used in determining the final modified gamut.

If the determination in block 430 is that the number of remaining vertices exceeds the threshold (i.e. there are ‘too many’ remaining vertices), the index may be reset for the modified gamut, and the method returns to block 408. In other examples the order of blocks 428 and 430 may be reversed such that comparing the second volume to the threshold in block 428 is performed after comparing the number of remaining vertices to a threshold number of vertices in block 430. The order in which the thresholds are checked depends on whether reducing the number of vertices or maintaining gamut volume is prioritised.

Once the hull is less than a threshold volume and the number of vertices remaining is less than the threshold number, the method terminates in block 432. In other examples, the method may terminate if the hull is less than a threshold volume or the number of vertices remaining is less than the threshold number (i.e. just one of the contitions of block 428 and 430), or after a predetermined number of iterations, or based on some other criteria.

The remaining vertices within the hull of the modified gamut after any and all iterations may be used for characterising a gamut, for example for calibrating a print apparatus, or determining a color mapping between color spaces for the print apparatus, or the like. The remaining hull vertices may provide colors for test patches to be printed.

In some examples the above method is performed on a hull of the initial color gamut, wherein the hull is a convex hull of the color gamut. In other examples the hull is an alpha shape of the color gamut.

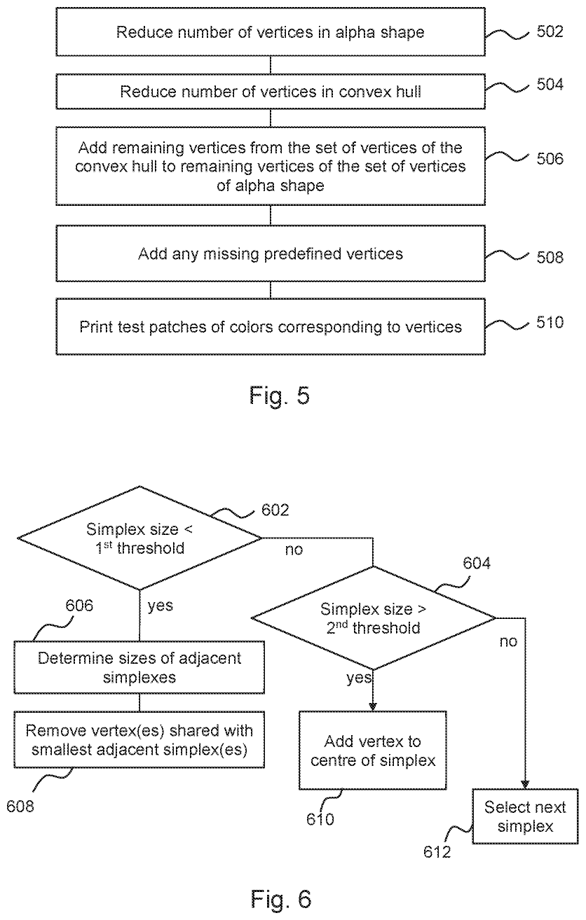

FIG. 5 shows an example of a method, which may be a method of determining a modified color gamut hull. In this example, in block 502 the method is performed on a hull of the initial color gamut, wherein the hull is an alpha shape with a finite alpha value, that is, the hull is not a convex hull. In block 502 the number of vertices in the alpha shape are reduced by performing the method of FIG. 1 or FIG. 4 on the vertices of the alpha shape. In block 504 the method is performed on a convex hull of the initial color gamut, for example by performing the method of FIG. 1 or FIG. 4 on the vertices of the alpha shape.

In block 506, the remaining vertices from the set of vertices of the convex hull are added to the remaining vertices of the set of vertices of the alpha shape. By adding the sampled vertices from the convex hull and alpha shape, volume loss may be reduced compared to just performing the sampling on just one of those hulls.

Blocks 502 and 504 may be performed in parallel or sequentially in any order.

Block 508 comprises determining if the remaining vertices comprise a predefined set of vertices and when the remaining vertices do not comprise the predefined set of one or more vertices, adding the predefined set of points to the set of remaining vertices. The predefined set of vertices may be vertices which are useful in characterising a gamut, for example the predefined set of vertices may include extremities such as the darkest and/or lightest points, and/or the most and/or least chromatic points. For example the predefined set of vertices may include the most or least chromatic points in a* and/or b* or may include a full hull in a*b* to ensure a hue ring of the gamut is included in the modified gamut hull. Such a method may also be carried out in relation to the method of FIG. 1 or FIG. 4.

In block 510, a printing apparatus is instructed to print at least one color based on the vertices of the modified gamut hull. In the example of FIG. 5, the image comprises test patches based on the vertices, and the method may comprise printing a plurality of test patches. In some examples, the test patches may be analysed, for example the method may comprise using scanning apparatus and/or a colorimeter to characterise the gamut of the printing apparatus, for example to verify whether colors print as expected and/or to provide an input for a calibration procedure. The gamut as a whole may be characterised by checking points on the hull of the gamut.

In general, any hull may be considered and/or combined. The threshold simplex size need not be the same for each hull.

FIG. 6 is an example of a method, which may be a computer implemented method and may be used in conjunction with the method of FIG. 1, 4 or 5. The method of FIG. 6 comprises a method for selecting a vertex for removal and/or a method for adding a vertex.

Block 602 comprises comparing the size of a simplex to a first threshold. If the simplex is larger than the threshold size then the method proceeds to block 604, which comprises comparing the size of a simplex to a second threshold, larger than the first threshold, Therefore, block 602 identifies simplexes of less than a minimum threshold size and block 604 identifies simplexes of greater than a larger threshold size.

For simplexes of less than the first threshold size (small simplexes), the method proceeds to block 606, which comprises calculating the sizes of the adjacent simplexes (i.e. any simplex with at least one vertex shared with the simplex under review. Block 608 comprises removing at least one vertex which is common to the first simplex and the smallest adjacent simplex(es). This may remove all but one vertex (in some examples, with the added condition that the removed vertex(es) is/are not also a vertex of another simplex from which a vertex has been removed, and/or is/are not already listed for removal as described above in relation to FIG. 3).

For simplexes which are larger than the second threshold size (large simplexes), the method proceeds to block 610, which comprises adding at least one vertex to the first set of vertices. For example, the vertex may be added to the simplex at the centroid of said simplex, for example computed as barycentric coordinates and/or as a convex combination of the vertices. This may result in a modified gamut hull with a more even density of vertices. This results in vertices being removed from simplexes which are small and points being added when simplexes are large, which may assist in generating an even distribution of vertices in the modified gamut hull. This process may also be carried out iteratively, to result in a hull defined by a set of simplexes which may be (or at least may be, in the main) between the first and second threshold in size.

If the simplex is between the first and second threshold sizes, the next simplex may be inspected (block 612).

As described above, the removal of vertices from simplexes may be performed iteratively for each simplex of an initial color gamut hull to form a modified color gamut hull. This modified color gamut hull may be further processed to reduce the number of vertices by iteratively applying the same process to each hull simplex of the modified color gamut, This process can be repeated until a suitable modified color gamut hull is achieved. For example the volume reduction may be calculated after each iteration and compared to a threshold and/or the number of remaining vertices may be determined after each iteration and compared to a threshold.

In a practical example, an initial 3D color gamut hull may comprise 8912 vertices, be tessellated into triangles and have a volume of 558410.58 (arbitrary units). Printing and scanning each of these vertices may consume significant printing resources, processing resources and time, However, a random sampling may not select vertices which characterise all regions of the gamut hull equally.

The methods set out herein may, after a first iteration based on a threshold set as the median of the sizes for the triangles, reduce the number of vertices to 4610 and reduce the volume by 0.2% to 557555.22. After a second iteration, with the threshold size redefined to the new median, the number of vertices is reduced to 2214 and the volume is reduced by 0.3% to 556505.38. After a third iteration the number of points is reduced to 962 and the volume is reduced by 0.9% to 553521.31. The modified gamut hull in this example then has 5 predetermined extremity points added (for example as described in relation to block 508 above) resulting in a final modified gamut hull with 967 points and a volume of 554385.55 (a volume reduction of 0.7%) and may be computed relatively efficiently. Therefore the number of vertices is reduced by approximately a factor of 10 and this can be achieved in a short period of time without undue consumption of processing power. The remaining vertices are well dispersed over the hull so provide a good even sampling of the hull of the gamut (from which the gamut as a whole may be characterised).

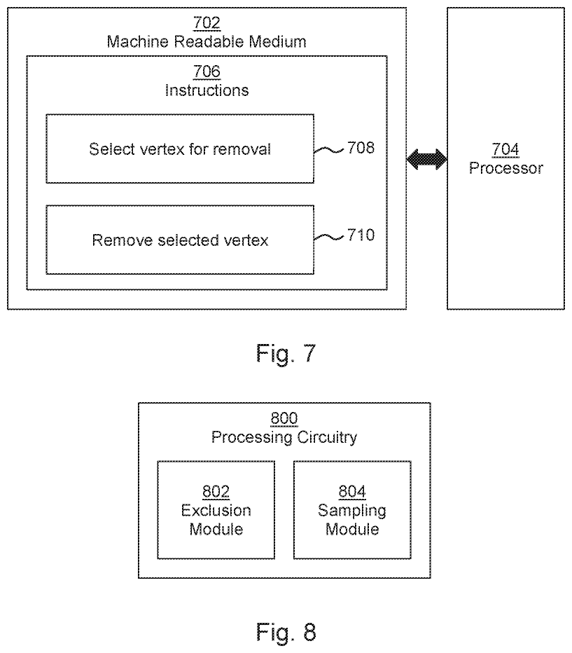

FIG. 7 shows an example of a machine-readable medium 702 associated with a processor 704, The machine-readable medium 702 stores instructions 706 which when executed by the processor 704 cause the processor 704 to carry out tasks. In this example, the instructions 706 comprise instructions 708 to cause the processor 704 to select a vertex of a simplex for removal, wherein the simplex is one simplex of a set of simplexes on a hull of an initial color gamut.

The instructions 706 further comprise instructions 710 to cause the processor 704 to remove the selected vertex to generate a modified color gamut hull, wherein the selection and removal is conditional on the size of the simplex being less than a threshold, as was described in relation to FIG. 1 and/or FIG. 4.

The instructions 706 of the machine-readable medium 702 may further comprise instructions to perform any of processes of the above described methods. For example, the instructions 706 may, when executed, cause the processor 704 to iteratively remove vertices from the gamut hull until a threshold volume criteria and/or a threshold number of vertices is reached. In some examples, the instructions 706 may, when executed, cause the processor 704 to add vertices to simplexes above a predetermined size (in some examples, iteratively) and/or to add vertices from a predetermined list of vertices and/or to combine the vertices of an alpha shape hull and a convex hull when generating the modified color gamut hull. In some examples, the instructions 706 may, when executed, cause the processor 704 to generate print control instructions to cause a print apparatus to print at least one test patch of a color corresponding to a remaining vertex in the modified color gamut hull.

FIG. 8 shows an example of processing circuitry 800. The processing circuitry 800 comprises an exclusion module 802, which, in use of the processing circuitry 800, excludes a vertex of a simplex of a set of simplexes defining a hull of an initial color gamut when said vertex belongs to a simplex with a size less than a threshold. The processing circuitry 800 further comprises a sampling module 804 which, in use of the processing circuitry 800, samples the hull of the color gamut by selecting the non-excluded vertices to generate a modified color gamut hull.

The processing circuitry 800 may be associated with or included within a printing apparatus. For example the processing circuitry 800 may be a computer which sends instructions to a printing apparatus. The printing apparatus may be a printer such as an inkjet printer.

The processing circuitry 800 may be capable of performing any of the processes described in relation to the above described methods. For example, the processing circuitry 800 may, in use thereof, iteratively exclude and/or remove vertices from the gamut hull until a threshold volume criteria and/or a threshold number of vertices is reached. In some examples, the processing circuitry 800 may, in use thereof, add vertices to simplexes above a predetermined size (in some examples, iteratively) and/or add vertices from a predetermined list of vertices and/or combine the vertices of an alpha shape hull and a convex hull when generating the modified color gamut hull. In some examples, the processing circuitry 800 may, in use thereof, generate print control instructions to cause a print apparatus (which may be a printing apparatus in which the processing circuitry 800 is provided) to print at least one test patch of a color corresponding to a remaining vertex in the modified color gamut hull.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
obtaining, by a processor, a first set of vertices of a set of simplexes defining a hull of an initial color gamut;
determining, by a processor, a value representing a size of a first simplex of the set of simplexes;
comparing, by a processor, the determined value to a first threshold; and
when the determined value is less than the first threshold, removing, by a processor, at least one vertex of the first simplex from the first set of vertices to determine a modified color gamut hull.

2. A method according to claim 1, wherein
the initial color gamut is a three dimensional color gamut;
the simplexes of the set of simplexes are triangles; and
determining the value representing the size comprises determining an area of a triangle.

3. A method according to claim 1 wherein removing at least one vertex of the first simplex comprises removing all but one vertex of the first simplex.

4. A method according to claim 1 further comprising calculating the first threshold by determining a median of values representing sizes of the simplexes in the set of simplexes.

5. A method according to claim 1 wherein the method further comprises, for each simplex of the set of simplexes;
determining a value representing a size of the simplex;
comparing the determined value to the first threshold; and
when the determined value is less than the first threshold, removing at least one vertex from that simplex.

6. A method according to claim 5 further comprising:
calculating a first volume of the hull of the initial color gamut prior to removal of any vertices;
calculating a second volume of the modified color gamut hull after removal of the vertices;
calculating a difference between the first volume and the second volume;
and, when the difference is less than a volume loss threshold, determining simplexes based on the remaining vertices, and for each determined simplex:
determining a value representing a size of the simplex;
comparing the determined value to the first threshold; and
when the determined value is less than the threshold, removing at least one vertex from that simplex to determine a further modified color gamut hull.

7. A method according to claim 5 further comprising:
when a number of remaining vertices is greater than a threshold number of vertices, determining simplexes based on the remaining vertices, and for each determined simplex:
determining a value representing a size of the simplex;
comparing the determined value to the first threshold; and
when the determined value is less than the threshold, removing at least one vertex from that simplex to determine a further modified color gamut hull.

8. A method according to claim 1 wherein the hull of the initial color gamut is an alpha shape with a finite alpha value, and the method further comprises:
determining a second set of vertices of a second set of simplexes of a convex hull of the initial color gamut;
for each simplex of the second set of simplexes:
determining a value representing a size of the simplex;
comparing the determined value to the first threshold;
when the determined value is less than the threshold, removing at least one vertex from that simplex; and
adding the remaining vertices from the second set of vertices to remaining vertices of the first set of vertices.

9. A method according to claim 1,
wherein removal of at least one vertex of a first simplex is conditional on that vertex not being a vertex of a second simplex, wherein the second simplex has at least one removed vertex.

10. A method according to claim 1 further comprising:
determining if the remaining vertices comprise a predefined set of points; and
when the remaining vertices do not comprise the predefined set of points, adding the predefined set of points to the modified color gamut hull.

11. A method according to claim 1, wherein removing at least one vertex comprises:
determining a size of each simplex which is adjacent to the first simplex;
identifying a smallest adjacent simplex; and
removing at least one vertex which is common to the first simplex and the smallest adjacent simplex.

12. A method according to claim 1 further comprising:
comparing the value representing the size of the first simplex to a second threshold; and
when the value is greater than the second threshold, adding at least one vertex to the first set of vertices,

13. A method according to claim 1 further comprising:
instructing a printing apparatus to print test patches corresponding to the vertices of the modified color gamut hull.

14. A machine-readable medium storing instructions which when executed by a processor cause the processor to:
select a vertex of a simplex for removal, wherein the simplex is one simplex of a set of simplexes on a hull of an initial color gamut;
remove the selected vertex to generate a modified color gamut hull; and
wherein selection and removal of a vertex is conditional on a size of the simplex being less than a threshold,

15. Processing circuitry comprising:
an exclusion module to exclude a vertex of a simplex of a set of simplexes defining a hull of an initial color gamut when said vertex belongs to a simplex with a size less than a threshold; and
a sampling module to sample the hull of the initial color gamut by selecting non-excluded vertices to generate a modified color gamut hull.
